(19) United States
(12) Patent Application Publication
(10) Pub. No.: US 2021/0080954 A1
(43) Pub. Date: Mar. 18, 2021

(54) METHOD FOR UNMANNED VEHICLE SWAPPING

(71) Applicant: Travis Kunkel, Mineral Wells, TX (US)

(72) Inventor: Travis Kunkel, Mineral Wells, TX (US)

(21) Appl. No.: 16/573,119

(22) Filed: Sep. 17, 2019

(51) Int. Cl. G05D 1/00; G05D 1/10; B64C 39/02

(52) U.S. Cl. CPC G05D 1/0088; G05D 1/101; G05D 1/0022; B64C 2201/146; B64C 39/024; B64C 2201/042; G05D 1/0027

(57) ABSTRACT

A functionality utilizing a centrally controlled strategy for continuous communication to specific autonomous vehicles, or drones, assigned specific missions with the ability to be replaced during the mission. This functionality is an improvement on existing swarm and leader-follower tactics as it retains control of the drones at a central command center, allowing the drones to both receive individual commands from the hub but also operate independently of it with direct pilot control. This direct communication allows for real time process of ordered substitution to replace any drone during the mission.

### FIELD OF THE INVENTION

The present invention relates to a novel method for unmanned vehicles intending to receive instructions and carry out a mission, while being able to be replaced by a spare unmanned vehicle during the mission. If a mission lasts longer than the power source carried by the vehicle or suffer a malfunction, a spare unmanned vehicle would be triggered to replace the original unmanned vehicle. The method disclosed herein configures a centrally controlled strategy for constant communication with unmanned vehicles during a specified mission including a process of ordered substitution. This application uses unmanned aerial vehicles, also known popularly as drones, to describe the invention, but the invention can include wheeled terrestrial vehicles, submarines, or any other vehicle that can be operated autonomously.

### BACKGROUND

Individuals can use autonomous vehicles (“AV”) as instruments for specific missions, such as surveillance, lighting, and entertainment. Embodiments of AVs are configured to operate in air, on land, and in water, in this embodiment the AV is configured to operate in air, the scope of this patent should not be limited to this configured embodiment but to all configurations thereof.

A typical autonomous vehicle comprises a local memory and electric motor powered by a battery that is programmed to perform predetermined missions and flight plans. Alternatively, an AV could be driven using a gas engine fed by an AV-mounted fuel tank.

Multiple AVs can be used at the same time as a team for a particular mission. Once an AV completes the mission, a user can replace the AV's battery or recharge its existing battery for its next use. If an AV drains all of its power during the mission, the AV will either slowly lower itself to the ground to be collected by the owner, return to its landing location or in extreme circumstances, crash in an emergency landing. This causes the owner to have to physically find and collect the AV and charge or replace battery in order to use it again. As a result there may be an empty slot in the AV team during mission that will only be filled when the AV is charged or has its battery replaced. While it is possible to fill that slot with the recharged AV, or a separate AV, the owner would prefer a system of an ordered substitution to make this transition smoother. If replacing an AV during a mission became simpler, missions would be more reliable, easier, and more efficient. The present invention allows for a system of an ordered substitution from a centrally controlled strategy to replace AVs during a mission.

### SUMMARY OF THE INVENTION

The present invention comprises a system of an ordered substitution for AVs from a centrally controlled strategy, and includes a command center hub, one or more AVs, and a method for replacement.

In one of many alternative embodiments, the functionality utilizes a centrally controlled strategy. This differs from swarm and leader/follower tactics as it retains control of the unmanned vehicles at a central command center, allowing the AVs to both receive individual commands from the hub but also to be operated independently of it with direct pilot control. This allows for specific formations in all axes (X, Y, Z) in a designated diameter around a specified location (“centroid”). Each vehicle has an independent and unique fixed path automatically generated for it, including such variables as altitudes and approach trajectories to reduce the possibility of collision with other drones executing the overall mission. This embodiment enables mobile, mission-directed autonomous hardware to interact in such a way as to create a continuous presence and desired activity level at a prescribed location or series of locations. This functionality allows for continuous engagement without cessation of the mission due to vehicle or pilot fatigue while allowing for pilot direct control at any given time.

In the current embodiment, the vehicles constantly communicate with the hub and at no time do they operate without data interchange with the hub or pilot via a radio controller or other means. This results in multiple iterations per second of real-time information from all drones active on the mission, including those entering and exiting. This constant communication allows the pilot to have robust control and efficacy of the drones for the allotted mission.

The control center hub includes software controlling the initial mission planning (vehicle positioning), data interchange, and drone movement during the mission. In this embodiment “mission” is understood to be the positioning of the vehicles at the desired location and execution of the task to be performed. In this embodiment it is understood that each vehicle is assigned to have its own individual and unique mission that is completed upon return to the base, the command center sets a static triggering level relative to the end user and their personal desires for reserve battery level that they want the drone to return on. In this embodiment the global or overall mission objective is the sum of the individual missions, this is contrasted to the typical swarm and leader/follower technology and mission strategy.

In other embodiments, each AV may be directed to a mission without constant contact with a hub, but rather act to perform a pre-programmed mission, and then simply return to the programmed return location when it is complete, or when its fuel is spent, or some other triggering event occurs, such as a selected time when a new AV should take its place.

### BRIEF DESCRIPTION OF THE DRAWINGS

FIG. 1 shows the flow chart for the drone continual relief process.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and “comprising”, when used in this specification, specify the presence of stated features, steps, operations, elements, and components, but do not preclude the presence or addition of one or more other features, steps, operations, elements, components, or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the FIGURES or description below. As previously stated, though this application uses unmanned aerial drones, the same process can be used to automate similar terrestrial or maritime drones, or even submarines.

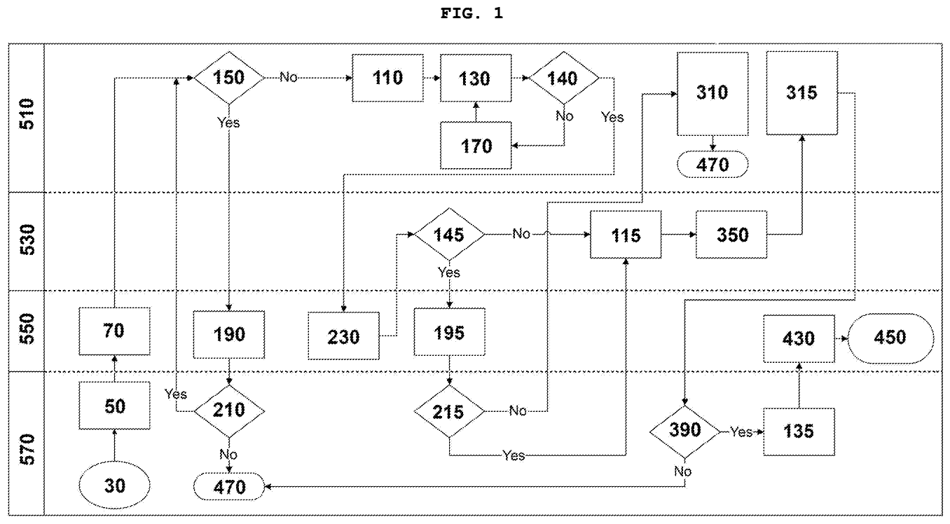

The present invention will now be described by referencing the appended FIGURES representing preferred embodiments. FIG. 1 shows the flow chart for the drone relief process.

Starting (Step 30): In the current embodiment, the user, hereafter referenced as the Pilot 570 will start the process by determining the mission and how many vehicles will be required for the mission, the specific location (latitude, longitude, elevation), the elevation (or depth) of the vehicles, distance from the location each vehicle is to assume and the minimal distance from each other, and other details as the Pilot 570 chooses. The example for this specification in this embodiment will be limited to two active drones, however the scope of this invention is not limited to two drones; the number of drones being used for a mission will be decided by the Pilot 570.

Programming the Ground Control System (step 50): Once determined, the Pilot 570 will set the requisite parameters within the hub operating system or Ground Control System 550 (“GCS”) and the Pilot 570 will turn on the vehicles and download the individual missions into each vehicle.

Programming Drone #1 (Step 70): Once the Pilot 570 has entered the details, the GCS 550 will load Drone #1 510 to be readied for a mission.

Drone #1 Internal Check (Step 150): Before taking off, Drone #1 510 will send its operating conditions to the GCS 550 to make sure it is ready for take-off, the GCS 550 checking for sufficient battery power and other mission critical parameters, such as a radio function check to ensure that Drone #1 510 is prepared to meet the needs of the programmed mission.

GCS Evaluation (Step 190): If the power is found to be less than the threshold required by the Ground Control System 550 in step 150, or any other critical parameter does not meet operational needs of the mission, Drone #1 will stand down and the GCS 550 further evaluate the operating conditions and will alert the Pilot 570.

Pilot Evaluation (Step 210): Once alerted, the Pilot 570 evaluates the reported conditions of Drone #1 to determine why the GCS 550 indicated an alert and change the battery 210 and make any other corrections. If the Pilot 570 chooses to change the battery, the drone can continue with repeating the Drone #1 Internal Check (Step 150), or the Pilot 570 chooses to not change the battery or determines that Drone #1 should not be used in the contemplated mission, the Pilot will end the mission 470 for Drone #1 510.

Mission (Step 110): After Drone #1 510 assesses that its battery power and other parameters are sufficient to meet operational requirements of the mission, it will move to the proper location and once on location, Drone #1 will conduct its programmed mission.

The mission could be to simply point a camera in a direction or to follow a moving target, carry a payload to a specific farm location, or shine a light on a dark night at a worksite until dawn—the possibilities are endless.

Drone #1 Condition Reporting (Step 130): Drone #1 continuously self-monitors its operating conditions while conducting its programmed mission.

Evaluate Monitored Conditions (Step 140): Depending on the instructions and system, Drone #1 will report its monitored conditions to the GCS for evaluation and further instructions to remain on mission or return home, or Drone #1 may be configured to self-monitor conditions. Such conditions could include checking the remaining charge on its battery to see if the battery power is less than a set threshold, or fuel is running low in a tank, a payload has been dispersed, or dawn has arrived, etc.

Ongoing Mission (Step 170): As long as Drone #1 assesses that no conditions suggesting it should interrupt its operations (Step 140), it will continue with its mission until the mission is completed. While this explanation discusses primarily battery charge, this step monitors all operating conditions during the mission as discussed above.

Drone Replacement (Steps 140, 230): As the mission progresses, Drone #1 will either complete its mission or reach a pre-determined triggering event and either signal the GCS or simply take the next step in a mission to begin the process of an ordered substitution. Such triggering events can include a low battery threshold, a set time, a detected radio signal, or even an audible signal. If the triggering event is a condition determining that the mission is complete, Drone #1 simply returns home. (This condition is not shown on FIG. 1.)

Drone Replacement (Step 230, continued): Once triggered, a second AV, referenced here as Drone #2 530, will replace the first AV at a desired location, either in the same position or another location as designated, as directed. The path may be non-direct, through a calculated waypoint to the side of the destination.

Drone #2 Preparation (Step 145, 195, 215): Before the secondary drone 530 launches, it performs a pre-mission Drone #2 Internal Check (Step 145) similar to those steps taken by Drone #1 described by Steps 150, 190 and 210—checking its battery power and other starting conditions to ensure mission readiness, and if Drone #2 is not prepared for mission (a “yes” on FIG. 1 following Step 145), the GCS 550 will issue a “Do not engage in mission” order (Step 195) to Drone #2 530.

Pilot Evaluation (Step 215): As with Drone #1 510, the Pilot 570 has the choice to change the battery. If the Pilot 570 chooses to change the battery, Drone #2 530 can continue to move to location after the battery change and continue with the programmed mission (Step 115).

Drone #1 Return To Mission (Step 310): If the Pilot 570 does not change the battery of Drone #2 530 or make other necessary corrective action, then Drone #1 510 can be directed to complete the mission as much as possible and then return from goal 310, and end the mission (Step 470).

Drone #2 Relieves Drone #1 (Step 350): Following the evaluation of Drone #2 530 in Step 215 and conclusion that Drone #2 530 is mission ready with sufficient battery power over a set threshold and all other operating conditions are satisfied, Drone #2 530 will relieve Drone #1 510 at its programmed location. Drone #1 510 then returns to its home location or other designated location as programmed.

Drone #2 Continues Mission (Step 315). Once Drone #2 530 has replaced Drone #1 510 at the mission location, Drone #2 530 will continue with the programmed mission until a triggering event occurs, which could be the end of the mission, low battery, low fuel, an emptied payload, or any other detected change in conditions warranting the end of Drone #2's 530 work on location.

Continuous Cycle Preparation (Step 390). Once a triggering event occurs during Step 315 to end Drone #2's 530 time on mission location, the Pilot 570 has the choice to prepare to relieve Drone #2 530 by preparing Drone #1 510 for its next shift by changing batteries, top off fuel tanks, refill a payload, etc., or to end the mission (shown as Step 470).

Re-Prepare Drone 1 (Steps 135): The Pilot will ensure that the pre-mission checklist for Drone #1 510 is capable of continuing the programmed mission.

Continuous Cycle Operations (Step 430): The GCS 550 will monitor the readiness and operational conditions of the two drones, cycling between drones as detailed above until the mission is complete (Step 450).

The process as described uses only two drones cycling between mission duty and preparation for mission duty, but the process is not limited to merely two units, with the duty change predicated upon some change in operational conditions that calls for a replacement or the end of a mission.

The process described can include continuous communication with a GCS 550 with instructions coming from the GCS, or manually through a Pilot 570.

Legend of operational steps and system elements:
30 Start
50 Programming the Ground Control System
70 Programming Drone #1
110 Complete Mission
115 Ongoing Mission Drone #2
130 Drone #1 Condition Reporting
135 Re-Prepare Drone 1
140 Evaluate Monitored Conditions
145 Drone #2 Internal Check
150 Drone #1 Internal Check
170 Ongoing Mission
190 GCS Evaluation #Drone 1
195 GCS Evaluation #Drone 2
210, 215 Pilot Evaluation
230 Drone Replacement
330 Move to Goal
270 Do not engage in mission
310 Drone #1 Return To Mission
315 Drone #2 Continues Mission
350 Drone #2 Relieves Drone #1
390 Continuous Cycle Preparation
430 Drone #1 readied for mission (Drone #2 relief)
450 Process continues with drones replacing each other until end user decides global mission is complete
470 End Mission
510 Drone #1
530 Drone #2
550 Ground Control System
570 Pilot

The inventor claims:

1. An autonomous vehicle system, comprising:
at least one autonomous vehicle (“AV”) that is powered at least in part by a fuel system;
a storage element that provides power to the fuel system;
a control system which accepts a user-programmable mission, such mission to include navigating the AV from a start point to a mission location while avoiding obstacles as it travels, performing a desired action for the AV to take at the mission location, remaining a user-determined length of time, and then navigating to a user-determined return location.

2. The AV system described in claim 1, further comprising:
a fuel gauge that monitors the fuel system;
the control system further capable of collecting samples from the fuel gauge and calculating when the AV should leave the mission location and navigate to the return location so that the AV has sufficient fuel to travel to the return location based on a user-determined margin of margin of error and the fuel required to travel from the start location to the mission location.

3. The AV system described in claim 1 as applied to an aerial vehicle, the control system additionally able to determine the expected difference in fuel usage traveling to the return location from a mission location and adjusting the length of time that the AV can remain at the mission location and still have sufficient fuel to navigate to the return location.

4. The AV system described in claim 1, further comprising a command center hub that can communicate with an AV, with communications occurring by a physical wire connection, wireless communications, or both.

5. The AV system described in claim 4, further comprising a command center hub that can communicate with an AV and give it instructions regarding a mission.

6. The AV system described in claim 1, further comprising at least two autonomous vehicles capable of coordinating their positions and avoid collisions, and programmable to accomplish a mission in accordance with user programming.

7. The AV system described in claim 5, further comprising at least two autonomous vehicles capable of coordinating their positions and avoid collisions, and programmable to accomplish a mission in accordance with user programming, and further capable of redirecting missions from the hub.

8. The AV system described in claim 7, in which an AV performed a fuel check and prevents its participation in a mission that is less than a user-set threshold before the AV is placed on a mission, giving a user an opportunity to change a battery, put a different AV into the mission, or take other action as circumstances differ.

9. The AV system described in claim 8, in which a set of at least two AVs can work in tandem, each one giving the other a recharging or refueling break while the other is on the mission.
